(19) United States
(12) Patent Application Publication
(10) Pub. No.: US 2026/0063869 A1
(43) Pub. Date: Mar. 5, 2026

(54) OPTICAL LENS ASSEMBLY

(71) Applicant: NEWMAX TECHNOLOGY CO., LTD., Taichung City (TW)

(72) Inventors: Xiao-Ting GENG, Taichung City (TW); Sian-Chih KE, Taichung City (TW); Kuo-Chun HSIAO, Taichung City (TW)

(21) Appl. No.: 18/929,515

(22) Filed: Oct. 28, 2024

(30) Foreign Application Priority Data
Sep. 2, 2024 (TW) 113133021

(51) Int. Cl. G02B 13/00; G02B 9/36

(52) U.S. Cl. CPC G02B 13/004; G02B 9/36

(57) ABSTRACT

An optical lens assembly includes: in order from an object side to an image side: a first lens with positive refractive power, including an image-side surface being convex in a paraxial region thereof; a second lens with negative refractive power, a third lens; and a fourth lens. Wherein a thickness of the third lens at a maximum effective diameter position of the third lens is ET3, a thickness of the fourth lens at a maximum effective diameter position of the fourth lens is ET4, and the following condition is satisfied: 0.48<ET3/ET4<1.50.

### BACKGROUND

### Field of the Invention

The present invention relates to an optical lens assembly, and more particularly to an optical lens assembly applicable to electronic devices.

### Description of Related Art

Miniaturized photographing modules with high image resolution have been the standard equipment for various mobile devices, and a smaller pixel size of image sensor could be made due to the advanced technologies of semiconductor process, there's an increasing demand for photographing modules to feature finer image resolution and better image quality. However, conventional photographing modules used in mobile devices, such as, mobile phones or tablet computers, and in other wearable electronic devices, in addition to the requirements for the performance thereof, such as high image quality and resolution, are required to have an optical zoom function, so the photographing modules have gradually attracted the attention of consumers. Understandably, when the zoom magnification increases, the total length of the photographing module increases, so mobile electronic products become more cumbersome. Therefore, how to develop a miniaturized photographing module having a long focal length is the technical bottleneck to overcome at present.

The present invention mitigates and/or obviates the aforementioned disadvantages.

### SUMMARY

The objective of the present invention is to provide an optical lens assembly, and the optical lens assembly has a total of four lenses with refractive power. When a specific condition is satisfied, the optical lens assembly can achieve a long focal length and a compact size.

Therefore, an optical lens assembly in accordance with an embodiment of the present invention includes, in order from an object side to an image side: a first lens with positive refractive power, including an image-side surface being convex in a paraxial region thereof; a second lens with negative refractive power, a third lens; and a fourth lens. Wherein a thickness of the third lens at a maximum effective diameter position of the third lens is ET3, a thickness of the fourth lens at a maximum effective diameter position of the fourth lens is ET4, a distance from an object-side surface of the first lens to an image plane along an optical axis is TTL, a maximum image height of the optical lens assembly is IMH, a maximum field of view of the optical lens assembly is FOV, a focal length of the optical lens assembly is f, a focal length of the first lens is f1, a focal length of the second lens is f2, an entrance pupil diameter of the optical lens assembly is EPD, a radius of curvature of the object-side surface of the first lens is R1, a radius of curvature of the image-side surface of the first lens is R2, a radius of curvature of an object-side surface of the fourth lens is R7, a radius of curvature of an image-side surface of the fourth lens is R8, a thickness of the first lens along the optical axis is CT1, a thickness of the second lens along the optical axis is CT2, a thickness of the third lens along the optical axis is CT3, a thickness of the fourth lens along the optical axis is CT4.

When 0.48<ET3/ET4<1.50 is satisfied, it is conducive to making the injection molding of lenses easy to enhance the formability of the lenses.

When 1.14<TTL/(2*IMH)<1.74 is satisfied, it can effectively ensure that the image quality of the optical lens assembly and the length is as compact as possible, so that the optical lens assembly can better meet the dimensional requirements.

When 30°<FOV<47° is satisfied, the overall size of the optical lens assembly can be effectively reduced, so that the optical lens assembly can meet the requirement of miniaturization.

When 0.37<f1/f<0.66 is satisfied, it can reduce the deflection angle of the light and improve the image quality of the optical lens assembly.

When 4.42 mm<EPD<7.0 mm is satisfied, it can effectively increase the amount of incident light of the optical lens assembly and enhance the image quality of the optical lens assembly in the dark environment.

When 0.35<R7/(R7+R8)<0.62 is satisfied, the on-axial spherical aberration produced by the optical lens assembly is constrained in a reasonable interval, thus ensuring the image quality of the on-axial field of view.

When 1.36<f1/R1<2.04 is satisfied, it is conducive to reducing the comatic aberration in the on-axis and off-axis fields of view to ensure that the optical lens assembly has a better image quality.

When 1.18<(CT1+CT2)/(CT3+CT4)<2.35 is satisfied, it is conducive to making the injection molding of lenses easy, while ensuring better image quality.

When 0.37<CT4/CT3<1.76 is satisfied, it is conducive to making the third lens and the fourth lens easy to process, while ensuring better image quality.

When 0.03<R1/|R2|<0.21 is satisfied, it is conducive to making the contribution of curvature of field of the image-side surface of the first lens be in a reasonable range.

When 0.94<f2|/f1<1.35 is satisfied, it is conducive to effectively avoiding the over-deflection of light and reducing the difficulty of processing and assembly of lenses.

When 4.65<|R8|/CT4<11.03 is satisfied, it is conducive to reducing the thickness sensitivity of the optical lens assembly and correcting the curvature of field.

When 0.78<(f1−f2)/f<1.43 is satisfied, the on-axial spherical aberration produced by the optical lens assembly can be constrained in the reasonable interval, thus ensuring the image quality of the on-axial field of view.

When 1.83<f/EPD<2.97 is satisfied, it can effectively balance the aberrations related with the optical lens assembly and an aperture, thus ensuring the resolution of image on the axis.

Moreover, a photographing module in accordance with an embodiment of the present invention includes a lens barrel, the aforementioned optical lens assembly disposed in the lens barrel, and an image sensor disposed on the image plane of the optical lens assembly.

The present invention will be presented in further details from the following descriptions with the accompanying drawings, which show, for purpose of illustrations only, the preferred embodiments in accordance with the present invention.

### BRIEF DESCRIPTION OF THE DRAWINGS

FIG. 1A is a schematic view of an optical lens assembly in accordance with a first embodiment of the present invention;

FIG. 1B is a schematic diagram showing, in order from left to right, the field curvature curve and the distortion curve of the first embodiment of the present invention;

FIG. 2A is a schematic view of an optical lens assembly in accordance with a second embodiment of the present invention;

FIG. 2B is a schematic diagram showing, in order from left to right, the field curvature curve and the distortion curve of the second embodiment of the present invention;

FIG. 3A is a schematic view of an optical lens assembly in accordance with a third embodiment of the present invention;

FIG. 3B is a schematic diagram showing, in order from left to right, the field curvature curve and the distortion curve of the third embodiment of the present invention;

FIG. 4A is a schematic view of an optical lens assembly in accordance with a fourth embodiment of the present invention;

FIG. 4B is a schematic diagram showing, in order from left to right, the field curvature curve and the distortion curve of the fourth embodiment of the present invention;

FIG. 5A is a schematic view of an optical lens assembly in accordance with a fifth embodiment of the present invention;

FIG. 5B is a schematic diagram showing, in order from left to right, the field curvature curve and the distortion curve of the fifth embodiment of the present invention;

FIG. 6A is a schematic view of an optical lens assembly in accordance with a sixth embodiment of the present invention; and

FIG. 6B is a schematic diagram showing, in order from left to right, the field curvature curve and the distortion curve of the sixth embodiment of the present invention.

### DETAILED DESCRIPTION

### First Embodiment

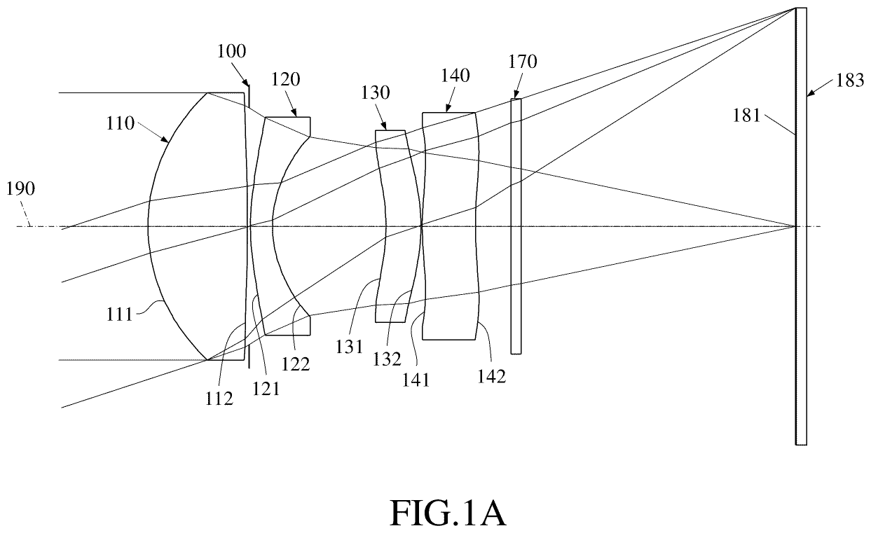

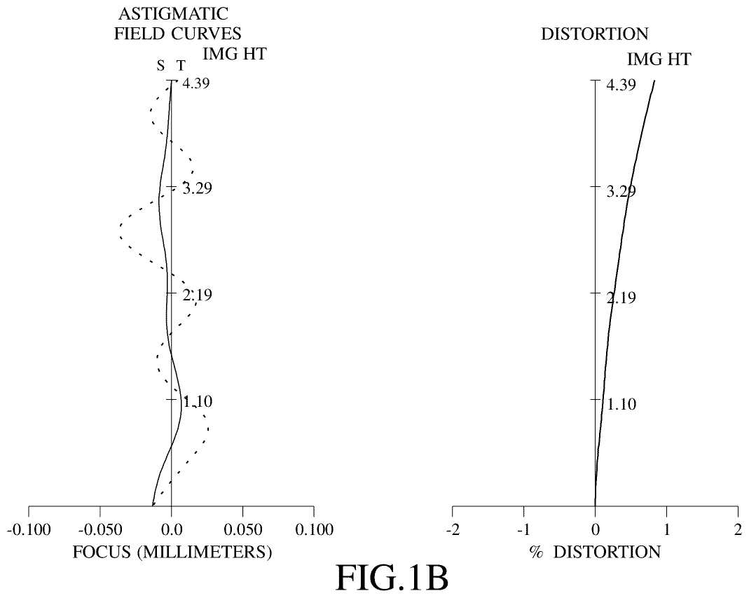

Referring to FIGS. 1A and 1B, FIG. 1A shows a schematic view of an optical lens assembly in accordance with a first embodiment of the present invention, and FIG. 1B shows, in order from left to right, the field curvature curve and the distortion curve of the first embodiment of the present invention. As shown in FIG. 1A, the optical lens assembly includes, in order from an object side to an image side: a first lens 110, a stop 100, a second lens 120, a third lens 130, a fourth lens 140, an optical filter 170, and an image plane 181. The optical lens assembly can cooperate with an image sensor 183 disposed on the image plane 181. The optical lens assembly has a total of four lenses with refractive power (110, 120, 130, 140), but is not limited thereto.

The first lens 110 with positive refractive power includes an object-side surface 111 and an image-side surface 112, the object-side surface 111 of the first lens 110 is convex in a paraxial region thereof, the image-side surface 112 of the first lens 110 is convex in a paraxial region thereof, the object-side surface 111 and the image-side surface 112 of the first lens 110 are aspheric, and the first lens 110 is made of plastic.

The second lens 120 with negative refractive power includes an object-side surface 121 and an image-side surface 122, the object-side surface 121 of the second lens 120 is convex in a paraxial region thereof, the image-side surface 122 of the second lens 120 is concave in a paraxial region thereof, the object-side surface 121 and the image-side surface 122 of the second lens 120 are aspheric, and the second lens 120 is made of plastic.

The third lens 130 with negative refractive power includes an object-side surface 131 and an image-side surface 132, the object-side surface 131 of the third lens 130 is concave in a paraxial region thereof, the image-side surface 132 of the third lens 130 is convex in a paraxial region thereof, the object-side surface 131 and the image-side surface 132 of the third lens 130 are aspheric, and the third lens 130 is made of plastic.

The fourth lens 140 with positive refractive power includes an object-side surface 141 and an image-side surface 142, the object-side surface 141 of the fourth lens 140 is convex in a paraxial region thereof, the image-side surface 142 of the fourth lens 140 is concave in a paraxial region thereof, the object-side surface 141 and the image-side surface 142 of the fourth lens 140 are aspheric, and the fourth lens 140 is made of plastic.

The optical filter 170 is made of glass, is located between the fourth lens 140 and the image plane 181, and has no influence on the focal length of the optical lens assembly. In the present embodiment, the optical filter 170 is selected from IR-cut filters that allow visible light to pass therethrough.

The curve equation for the aspheric surface profiles of the respective lenses of the first embodiment is expressed as follows:

$$z ( h ) = \frac{{ch}^{2}}{1 + {[ 1 - ( k + 1 ) {c}^{2} {h}^{2} ]}^{0.5}} + \sum ( {A}_{i} ) \cdot ( {h}^{i} )$$

wherein:
z represents the value of a reference position at a height of h with respect to a vertex of the surface of a lens along the optical axis 190;
c represents a paraxial curvature (i.e., a curvature of a lens surface in a paraxial region thereof) equal to 1/R (R: a paraxial radius of curvature);
h represents a vertical distance from the point on the curve of the aspheric surface to the optical axis 190;
k represents the conic constant; and
Ai represents the i-th order aspheric coefficient.

In the first embodiment of the optical lens assembly, a focal length of the optical lens assembly is f, a f-number of the optical lens assembly is Fno, a maximum field of view of the optical lens assembly is FOV, and the following conditions are satisfied: f=13.31 mm; Fno=2.48; and FOV=35.8 degrees.

In the first embodiment of the optical lens assembly, a thickness of the third lens 130 at a maximum effective diameter position of the third lens 130 is ET3, a thickness of the fourth lens 140 at a maximum effective diameter position of the fourth lens 140 is ET4, and the following condition is satisfied: ET3/ET4=0.57.

In the first embodiment of the optical lens assembly, a distance from the object-side surface 111 of the first lens 110 to the image plane 181 along the optical axis 190 is TTL, a maximum image height of the optical lens assembly is IMH, and the following condition is satisfied: TTL/(2*IMH)=1.51.

In the first embodiment of the optical lens assembly, a focal length of the first lens 110 is f1, the focal length of the optical lens assembly is f, and the following condition is satisfied: f1/f=0.43.

In the first embodiment of the optical lens assembly, an entrance pupil diameter of the optical lens assembly is EPD, and the following condition is satisfied:

$$EPD = 5.37 mm .$$

In the first embodiment of the optical lens assembly, a radius of curvature of the object-side surface 141 of the fourth lens 140 is R7, a radius of curvature of the image-side surface 142 of the fourth lens 140 is R8, and the following condition is satisfied: R7/(R7+R8)=0.42.

In the first embodiment of the optical lens assembly, the focal length of the first lens 110 is f1, a radius of curvature of the object-side surface 111 of the first lens 110 is R1, and the following condition is satisfied: f1/R1=1.66.

In the first embodiment of the optical lens assembly, a thickness of the first lens 110 along the optical axis 190 is CT1, a thickness of the second lens 120 along the optical axis 190 is CT2, a thickness of the third lens 130 along the optical axis 190 is CT3, a thickness of the fourth lens 140 along the optical axis 190 is CT4, and the following condition is satisfied: (CT1+CT2)/(CT3+CT4)=1.38.

In the first embodiment of the optical lens assembly, the thickness of the third lens 130 along the optical axis 190 is CT3, the thickness of the fourth lens 140 along the optical axis 190 is CT4, and the following condition is satisfied: CT4/CT3=1.53.

In the first embodiment of the optical lens assembly, the radius of curvature of the object-side surface 111 of the first lens 110 is R1, a radius of curvature of the image-side surface 112 of the first lens 110 is R2, and the following condition is satisfied:

$$R 1 / \vert R 2 \vert = 0.13 .$$

In the first embodiment of the optical lens assembly, the focal length of the first lens 110 is f1, a focal length of the second lens 120 is f2, and the following condition is satisfied: |f2|/f1=1.13.

In the first embodiment of the optical lens assembly, the radius of curvature of the image-side surface 142 of the fourth lens 140 is R8, the thickness of the fourth lens 140 along the optical axis 190 is CT4, and the following condition is satisfied:

$$\vert R 8 \vert / CT 4 = 6.58 .$$

In the first embodiment of the optical lens assembly, the focal length of the first lens 110 is f1, the focal length of the second lens 120 is f2, the focal length of the optical lens assembly is f, and the following condition is satisfied: (f1−f2)/f=0.92.

In the first embodiment of the optical lens assembly, the focal length of the optical lens assembly is f, the entrance pupil diameter of the optical lens assembly is EPD, and the following condition is satisfied: f/EPD=2.48.

Please refer to Tables 1-2. The detailed optical data of the respective elements in the optical lens assembly of the first embodiment is shown in Table 1, and the aspheric coefficients of the lenses in the first embodiment are shown in Table 2.

TABLE 1
Embodiment 1
f = 13.31 mm, Fno = 2.48, FOV = 35.8°

| | | | | | | | Abbe | |
|---|---|---|---|---|---|---|---|---|
| | | Radius of | | Thickness/ | | Refractive | number | Focal |
| Surface | | curvature | | gap | Material | index (nd) | (vd) | length |
| 0 | Object | Infinity | | Infinity | | | | |
| 1 | First lens | 3.470 | (ASP) | 2.041 | Plastic | 1.54 | 55.9 | 5.75 |
| 2 | | −26.187 | (ASP) | 0.030 | | | | |
| 3 | Stop | Infinity | | 0.030 | | | | |
| 4 | Second lens | 4.847 | (ASP) | 0.450 | Plastic | 1.61 | 25.9 | −6.48 |
| 5 | | 2.116 | (ASP) | 2.330 | | | | |
| 6 | Third lens | −3.397 | (ASP) | 0.712 | Plastic | 1.66 | 20.4 | −39.50 |
| 7 | | −4.227 | (ASP) | 0.030 | | | | |
| 8 | Fourth lens | 5.119 | (ASP) | 1.091 | Plastic | 1.61 | 25.9 | 23.99 |
| 9 | | 7.175 | (ASP) | 0.725 | | | | |

| | | | | | | |
|---|---|---|---|---|---|---|
| 10 | Optical filter | Infinity | 0.210 | Glass | 1.52 | 64.2 |
| 11 | | Infinity | 5.623 | | | |
| 12 | Image plane | Infinity | 0.000 | | | |

The reference wavelength is 555 nm.

TABLE 2
Embodiment 1
Aspheric Coefficients

| Surface | 1 | 2 | 4 | 5 |
|---|---|---|---|---|
| K: | 3.5516E−01 | 0.0000E+00 | 0.0000E+00 | −8.4691E−02 |
| A2: | 0.0000E+00 | 0.0000E+00 | 0.0000E+00 | 0.0000E+00 |
| A4: | −1.2287E−03 | 6.6360E−03 | −1.7707E−02 | −2.8129E−02 |
| A6: | −2.5818E−04 | −4.9568E−03 | 3.0033E−03 | 6.8574E−03 |
| A8: | 1.0529E−04 | 2.6118E−03 | −3.9459E−03 | −3.1318E−03 |
| A10: | −9.5824E−05 | −7.8650E−04 | 5.2423E−03 | −5.8203E−04 |
| A12: | 4.6497E−05 | 1.2421E−04 | −3.7573E−03 | 3.8366E−03 |
| A14: | −1.4565E−05 | −3.0780E−06 | 1.7106E−03 | −4.0664E−03 |
| A16: | 2.9094E−06 | −2.6864E−06 | −5.2582E−04 | 2.2975E−03 |
| A18: | −3.6134E−07 | 5.2682E−07 | 1.0914E−04 | −7.8705E−04 |
| A20: | 2.5364E−08 | −4.3033E−08 | −1.4657E−05 | 1.6379E−04 |
| A22: | −7.7493E−10 | 1.3631E−09 | 1.1485E−06 | −1.9078E−05 |
| A24: | 0.0000E+00 | 0.0000E+00 | −3.9830E−08 | 9.5351E−07 |
| A26: | 0.0000E+00 | 0.0000E+00 | 0.0000E+00 | 0.0000E+00 |
| A28: | 0.0000E+00 | 0.0000E+00 | 0.0000E+00 | 0.0000E+00 |
| A30: | 0.0000E+00 | 0.0000E+00 | 0.0000E+00 | 0.0000E+00 |
| Surface | 6 | 7 | 8 | 9 |
| K: | 0.0000E+00 | 0.0000E+00 | 0.0000E+00 | 0.0000E+00 |
| A2: | 0.0000E+00 | 0.0000E+00 | 0.0000E+00 | 0.0000E+00 |
| A4: | 4.8707E−02 | −3.1096E−02 | −9.0000E−02 | −2.2092E−02 |
| A6: | −2.5227E−02 | 9.6399E−02 | 1.2841E−01 | −4.5879E−03 |
| A8: | 2.7609E−02 | −1.4410E−01 | −2.0137E−01 | 1.5423E−02 |
| A10: | −2.8578E−02 | 1.4873E−01 | 2.3930E−01 | −1.9174E−02 |
| A12: | 1.9404E−02 | −1.0608E−01 | −2.0770E−01 | 1.5645E−02 |
| A14: | −4.3731E−03 | 5.1750E−02 | 1.3177E−01 | −8.9568E−03 |
| A16: | −5.1365E−03 | −1.6571E−02 | −6.1244E−02 | 3.6772E−03 |
| A18: | 5.9208E−03 | 3.0307E−03 | 2.0774E−02 | −1.0883E−03 |
| A20: | −3.0769E−03 | −1.0158E−04 | −5.0744E−03 | 2.3024E−04 |
| A22: | 9.5190E−04 | −9.1619E−05 | 8.6781E−04 | −3.3951E−05 |
| A24: | −1.7956E−04 | 2.2559E−05 | −9.8475E−05 | 3.3131E−06 |
| A26: | 1.9140E−05 | −2.3166E−06 | 6.6520E−06 | −1.9220E−07 |
| A28: | −8.8660E−07 | 9.3067E−08 | −2.0222E−07 | 5.0162E−09 |
| A30: | 0.0000E+00 | 0.0000E+00 | 0.0000E+00 | 0.0000E+00 |

In Table 1, the units of the radius of curvature, the thickness, the gap and the focal length are expressed in mm, and the surface numbers 0-12 respectively represent the surfaces from the object-side to the image-side, wherein the surface 0 represents a gap between an object and the first lens 110; the surface 1 represents the thickness of the first lens 110 along the optical axis 190; the surface 2 represents a gap between the first lens 110 and the first lens 110; the surface 3 represents a gap between the stop 100 and second lens 120; the surface 4 represents the thickness of the second lens 120 along the stop 100; the surface 5 represents a gap between the second lens 120 and the third lens 130 along the optical axis 190; the surface 6 represents the thickness of the third lens 130 along the optical axis 190; the surface 7 represents a gap between the third lens 130 and the fourth lens 140 along the optical axis 190; the surface 8 represents the thickness of the fourth lens 140 along the optical axis 190; the surface 9 represents a gap between the fourth lens 140 and the optical filter 170 along the optical axis 190; the surface 10 represents the thickness of the optical filter 170 along the optical axis 190; the surface 11 represents a gap between the optical filter 170 and the image plane 181 along the optical axis 190; and the surface 12 represents the image plane 181. In table 2, k represents the conic constant of the equation of aspheric surface profiles, and A2, A4, A6, A8, A10, A12, A14, A16, A18, A20, A22, A24, A26, A28, and A30 represent the high-order aspheric coefficients. The respective tables presented below for respective one of other embodiments are based on the schematic view of this embodiment, and the definitions of parameters in the tables are the same as those in Tables 1-2 of the first embodiment. Therefore, an explanation in this regard will not be provided again.

### Second Embodiment

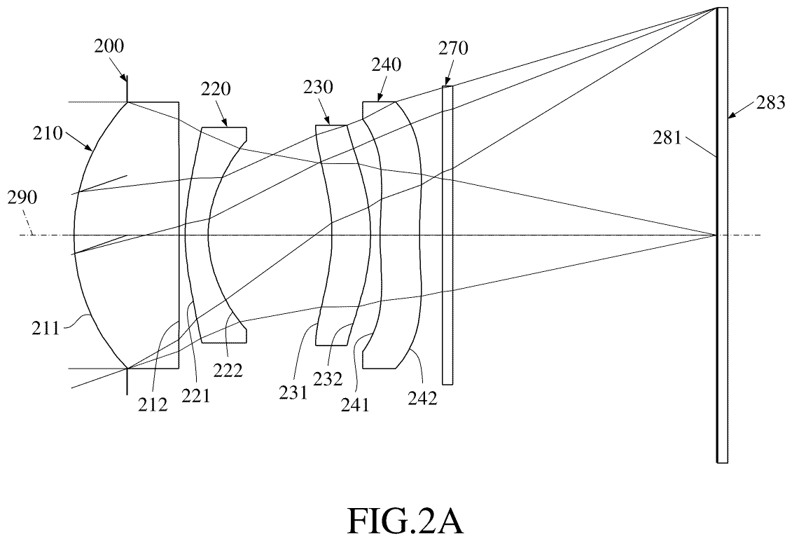

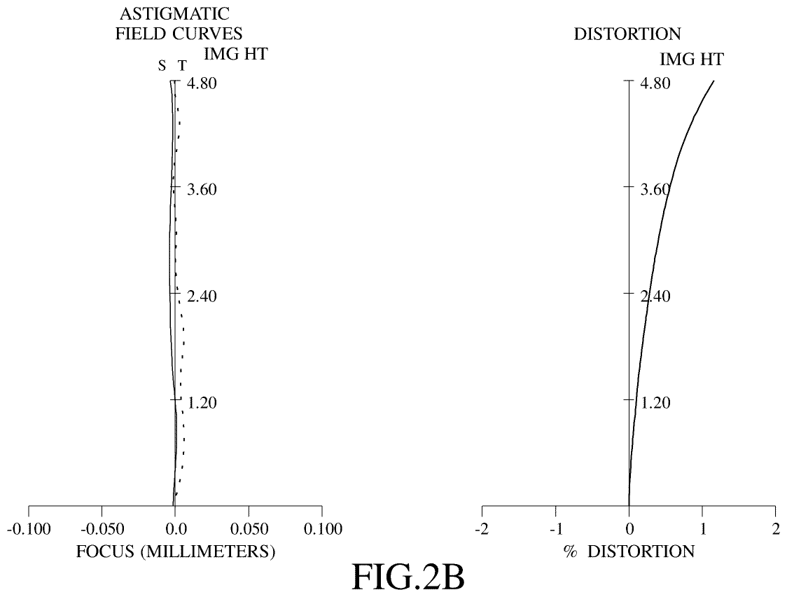

Referring to FIGS. 2A and 2B, FIG. 2A shows a schematic view of an optical lens assembly in accordance with a second embodiment of the present invention, and FIG. 2B shows, in order from left to right, the field curvature curve and the distortion curve of the second embodiment of the present invention. As shown in FIG. 2A, the optical lens assembly includes, in order from an object side to an image side: a stop 200, a first lens 210, a second lens 220, a third lens 230, a fourth lens 240, an optical filter 270, and an image plane 281. The optical lens assembly can cooperate with an image sensor 283 disposed on the image plane 281. The optical lens assembly has a total of four lenses with refractive power (210, 220, 230, 240), but is not limited thereto.

The first lens 210 with positive refractive power includes an object-side surface 211 and an image-side surface 212, the object-side surface 211 of the first lens 210 is convex in a paraxial region thereof, the image-side surface 212 of the first lens 210 is convex in a paraxial region thereof, the object-side surface 211 and the image-side surface 212 of the first lens 210 are aspheric, and the first lens 210 is made of plastic.

The second lens 220 with negative refractive power includes an object-side surface 221 and an image-side surface 222, the object-side surface 221 of the second lens 220 is convex in a paraxial region thereof, the image-side surface 222 of the second lens 220 is concave in a paraxial region thereof, the object-side surface 221 and the image-side surface 222 of the second lens 220 are aspheric, and the second lens 220 is made of plastic.

The third lens 230 with negative refractive power includes an object-side surface 231 and an image-side surface 232, the object-side surface 231 of the third lens 230 is concave in a paraxial region thereof, the image-side surface 232 of the third lens 230 is convex in a paraxial region thereof, the object-side surface 231 and the image-side surface 232 of the third lens 230 are aspheric, and the third lens 230 is made of plastic.

The fourth lens 240 with positive refractive power includes an object-side surface 241 and an image-side surface 242, the object-side surface 241 of the fourth lens 240 is convex in a paraxial region thereof, the image-side surface 242 of the fourth lens 240 is concave in a paraxial region thereof, the object-side surface 241 and the image-side surface 242 of the fourth lens 240 are aspheric, and the fourth lens 240 is made of plastic.

The optical filter 270 is made of glass, is located between the fourth lens 240 and the image plane 281, and has no influence on the focal length of the optical lens assembly. In the present embodiment, the optical filter 270 is selected from IR-cut filters that allow visible light to pass therethrough.

Please refer to Tables 3-4. The detailed optical data of the respective elements in the optical lens assembly of the second embodiment is shown in Table 3, and the aspheric coefficients of the lenses in the second embodiment are shown in Table 4.

TABLE 3
Embodiment 2
f = 14.5 mm, Fno = 2.58, FOV = 36.2°

| | | | | | | | Abbe | |
|---|---|---|---|---|---|---|---|---|
| | | Radius of | | Thickness/ | | Refractive | number | Focal |
| Surface | | curvature | | gap | Material | index (nd) | (vd) | length |
| 0 | Object | Infinity | | Infinity | | | | |
| 1 | Stop | Infinity | | −1.185 | | | | |
| 2 | First lens | 3.841 | (ASP) | 2.350 | Plastic | 1.54 | 55.9 | 6.82 |
| 3 | | −93.711 | (ASP) | 0.129 | | | | |
| 4 | Second lens | 4.361 | (ASP) | 0.514 | Plastic | 1.64 | 22.4 | −8.03 |
| 5 | | 2.262 | (ASP) | 2.758 | | | | |
| 6 | Third lens | −3.733 | (ASP) | 0.858 | Plastic | 1.67 | 19.2 | −1901.12 |
| 7 | | −4.091 | (ASP) | 0.217 | | | | |
| 8 | Fourth lens | 7.021 | (ASP) | 0.879 | Plastic | 1.54 | 55.9 | 63.14 |
| 9 | | 8.427 | (ASP) | 0.506 | | | | |

| | | | | | | |
|---|---|---|---|---|---|---|
| 10 | Optical filter | Infinity | 0.232 | Glass | 1.52 | 64.2 |
| 11 | | Infinity | 5.889 | | | |
| 12 | Image plane | Infinity | 0.000 | | | |

The reference wavelength is 555 nm.

TABLE 4
Embodiment 2
Aspheric Coefficients

| Surface | 2 | 3 | 4 | 5 |
|---|---|---|---|---|
| K: | −6.7762E−02 | −3.3607E+01 | −1.4500E+00 | −1.9862E−01 |
| A2: | 0.0000E+00 | 0.0000E+00 | 0.0000E+00 | 0.0000E+00 |
| A4: | 2.4348E−05 | 1.2515E−03 | −1.2213E−02 | −1.8382E−02 |
| A6: | −9.0463E−06 | −4.7384E−04 | 8.6653E−04 | 1.4280E−03 |
| A8: | −4.4255E−06 | 1.6999E−04 | 2.0162E−04 | 1.3318E−05 |
| A10: | 2.3155E−06 | −3.7321E−05 | −1.9127E−04 | −3.3705E−04 |
| A12: | −7.3606E−07 | 2.2751E−06 | 1.3145E−04 | 3.8222E−04 |
| A14: | 1.3423E−07 | 1.0747E−06 | −6.6541E−05 | −2.4606E−04 |
| A16: | −1.4661E−08 | −3.0103E−07 | 2.2519E−05 | 9.4696E−05 |
| A18: | 8.6687E−10 | 3.1956E−08 | −4.8975E−06 | −2.1589E−05 |
| A20: | −2.0831E−11 | −1.2755E−09 | 6.5647E−07 | 2.6939E−06 |
| A22: | 0.0000E+00 | 0.0000E+00 | −4.9331E−08 | −1.4186E−07 |
| A24: | 0.0000E+00 | 0.0000E+00 | 1.5886E−09 | 0.0000E+00 |
| A26: | 0.0000E+00 | 0.0000E+00 | 0.0000E+00 | 0.0000E+00 |
| A28: | 0.0000E+00 | 0.0000E+00 | 0.0000E+00 | 0.0000E+00 |
| A30: | 0.0000E+00 | 0.0000E+00 | 0.0000E+00 | 0.0000E+00 |
| Surface | 6 | 7 | 8 | 9 |
| K: | −7.8241E−01 | −8.0158E−01 | −7.6876E+01 | −3.9745E+01 |
| A2: | 0.0000E+00 | 0.0000E+00 | 0.0000E+00 | 0.0000E+00 |
| A4: | 1.8638E−02 | −1.2766E−02 | −2.9941E−02 | −2.2447E−02 |
| A6: | −5.1519E−03 | 1.8078E−02 | 9.5305E−03 | 3.7522E−03 |
| A8: | 4.4283E−03 | −1.1940E−02 | −4.0234E−03 | −7.5745E−04 |
| A10: | −3.7740E−03 | 5.9822E−03 | 1.2820E−03 | 1.0661E−04 |
| A12: | 2.3659E−03 | −2.2877E−03 | −2.9412E−04 | −9.7838E−06 |
| A14: | −1.0320E−03 | 6.5879E−04 | 4.4890E−05 | 4.8219E−07 |
| A16: | 3.0954E−04 | −1.3966E−04 | −4.0763E−06 | −9.5808E−09 |
| A18: | −6.2495E−05 | 2.1084E−05 | 1.6624E−07 | 0.0000E+00 |
| A20: | 8.1004E−06 | −2.1410E−06 | 0.0000E+00 | 0.0000E+00 |
| A22: | −6.0778E−07 | 1.3083E−07 | 0.0000E+00 | 0.0000E+00 |
| A24: | 2.0036E−08 | −3.6151E−09 | 0.0000E+00 | 0.0000E+00 |
| A26: | 0.0000E+00 | 0.0000E+00 | 0.0000E+00 | 0.0000E+00 |
| A28: | 0.0000E+00 | 0.0000E+00 | 0.0000E+00 | 0.0000E+00 |
| A30: | 0.0000E+00 | 0.0000E+00 | 0.0000E+00 | 0.0000E+00 |

In the second embodiment, the curve equation of the aspheric surface profiles of the aforementioned lenses is the same as the curve equation of the first embodiment. Also, the definitions of these parameters shown in the following table are the same as those stated in the first embodiment, so an explanation in this regard will not be provided again.

These parameters can be calculated from Tables 3-4 as the following values, and the following conditions in Table 5 are satisfied.

TABLE 5
Embodiment 2

| | | | |
|---|---|---|---|
| TTL/(2*IMH) | 1.49 | ET3/ET4 | 0.96 |
| f1/f | 0.47 | R1/\|R2\| | 0.04 |
| FOV[°] | 36.20 | \|f2\|/f1 | 1.18 |
| R7/(R7 + R8) | 0.45 | \|R8\|/CT4 | 9.59 |
| f1/R1 | 1.78 | EPD[mm] | 5.62 |
| (CT1 + CT2)/(CT3 + CT4) | 1.65 | (f1 − f2)/f | 1.02 |
| CT4/CT3 | 1.02 | f/EPD | 2.58 |

### Third Embodiment

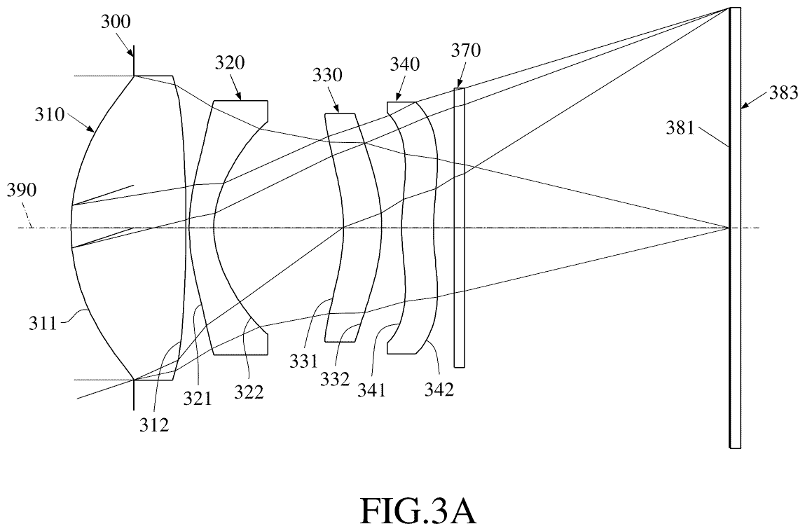

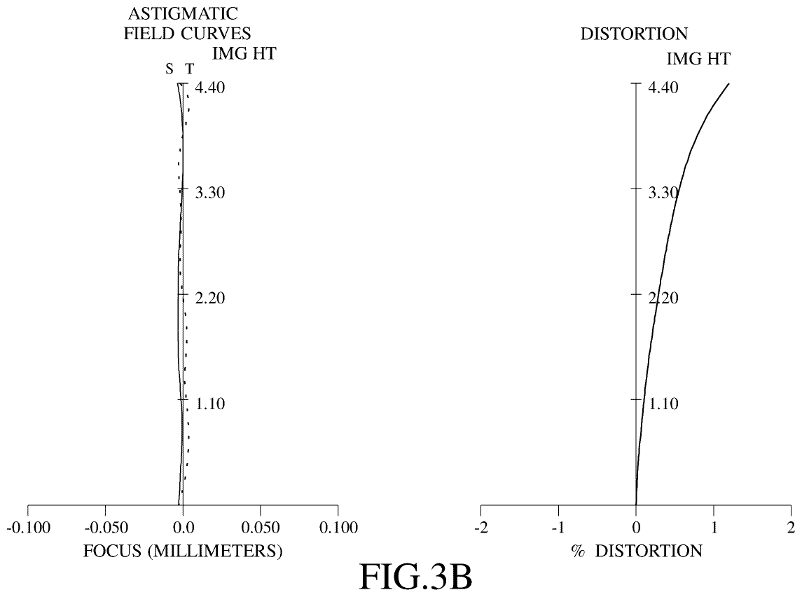

Referring to FIGS. 3A and 3B, FIG. 3A shows a schematic view of an optical lens assembly in accordance with a third embodiment of the present invention, and FIG. 3B shows, in order from left to right, the field curvature curve and the distortion curve of the third embodiment of the present invention. As shown in FIG. 3A, the optical lens assembly includes, in order from an object side to an image side: a stop 300, a first lens 310, a second lens 320, a third lens 330, a fourth lens 340, an optical filter 370, and an image plane 381. The optical lens assembly can cooperate with an image sensor 383 disposed on the image plane 381. The optical lens assembly has a total of four lenses with refractive power (310, 320, 330, 340), but is not limited thereto.

The first lens 310 with positive refractive power includes an object-side surface 311 and an image-side surface 312, the object-side surface 311 of the first lens 310 is convex in a paraxial region thereof, the image-side surface 312 of the first lens 310 is convex in a paraxial region thereof, the object-side surface 311 and the image-side surface 312 of the first lens 310 are aspheric, and the first lens 310 is made of plastic.

The second lens 320 with negative refractive power includes an object-side surface 321 and an image-side surface 322, the object-side surface 321 of the second lens 320 is convex in a paraxial region thereof, the image-side surface 322 of the second lens 320 is concave in a paraxial region thereof, the object-side surface 321 and the image-side surface 322 of the second lens 320 are aspheric, and the second lens 320 is made of plastic.

The third lens 330 with positive refractive power includes an object-side surface 331 and an image-side surface 332, the object-side surface 331 of the third lens 330 is concave in a paraxial region thereof, the image-side surface 332 of the third lens 330 is convex in a paraxial region thereof, the object-side surface 331 and the image-side surface 332 of the third lens 330 are aspheric, and the third lens 330 is made of plastic.

The fourth lens 340 with positive refractive power includes an object-side surface 341 and an image-side surface 342, the object-side surface 341 of the fourth lens 340 is convex in a paraxial region thereof, the image-side surface 342 of the fourth lens 340 is concave in a paraxial region thereof, the object-side surface 341 and the image-side surface 342 of the fourth lens 340 are aspheric, and the fourth lens 340 is made of plastic.

The optical filter 370 is made of glass, is located between the fourth lens 340 and the image plane 381, and has no influence on the focal length of the optical lens assembly. In the present embodiment, the optical filter 370 is selected from IR-cut filters that allow visible light to pass therethrough.

Please refer to Tables 6-7. The detailed optical data of the respective elements in the optical lens assembly of the third embodiment is shown in Table 6, and the aspheric coefficients of the lenses in the third embodiment are shown in Table 7.

TABLE 6
Embodiment 3
f = 13.08 mm, Fno = 2.15, FOV = 36.7°

| | | | | | | | Abbe | |
|---|---|---|---|---|---|---|---|---|
| | | Radius of | | Thickness/ | | Refractive | number | Focal |
| Surface | | curvature | | gap | Material | index (nd) | (vd) | length |
| 0 | Object | Infinity | | Infinity | | | | |
| 1 | Stop | Infinity | | −1.250 | | | | |
| 2 | First lens | 3.907 | (ASP) | 2.303 | Plastic | 1.54 | 55.9 | 6.25 |
| 3 | | −21.192 | (ASP) | 0.060 | | | | |
| 4 | Second lens | 3.531 | (ASP) | 0.495 | Plastic | 1.64 | 22.4 | −7.26 |
| 5 | | 1.905 | (ASP) | 2.593 | | | | |
| 6 | Third lens | −3.494 | (ASP) | 0.760 | Plastic | 1.67 | 19.2 | 105.02 |
| 7 | | −3.622 | (ASP) | 0.404 | | | | |
| 8 | Fourth lens | 4.424 | (ASP) | 0.636 | Plastic | 1.54 | 55.9 | 92.11 |
| 9 | | 4.604 | (ASP) | 0.413 | | | | |

| | | | | | | |
|---|---|---|---|---|---|---|
| 10 | Optical filter | Infinity | 0.210 | Glass | 1.52 | 64.2 |
| 11 | | Infinity | 5.298 | | | |
| 12 | Image plane | Infinity | 0.000 | | | |

The reference wavelength is 555 nm.

TABLE 7
Embodiment 3
Aspheric Coefficients

| Surface | 2 | 3 | 4 | 5 |
|---|---|---|---|---|
| K: | −1.2846E−01 | 5.7349E+00 | −1.6811E+00 | −3.0594E−01 |
| A2: | 0.0000E+00 | 0.0000E+00 | 0.0000E+00 | 0.0000E+00 |
| A4: | −4.0566E−05 | 3.5740E−03 | −1.7329E−02 | −3.2489E−02 |
| A6: | −5.0326E−05 | −1.5290E−03 | 2.3175E−03 | 4.1522E−03 |
| A8: | −1.2712E−05 | 5.9681E−04 | −6.2443E−04 | −1.8657E−03 |
| A10: | 7.9594E−06 | −2.0548E−04 | 4.7128E−04 | 9.4382E−04 |
| A12: | −2.8387E−06 | 4.9623E−05 | −2.7971E−04 | −3.8126E−04 |
| A14: | 5.1701E−07 | −7.8133E−06 | 1.0193E−04 | 4.0823E−05 |
| A16: | −5.4963E−08 | 7.5612E−07 | −2.2559E−05 | 3.1282E−05 |
| A18: | 3.1365E−09 | −4.0830E−08 | 2.9794E−06 | −1.4460E−05 |
| A20: | −7.8877E−11 | 9.4094E−10 | −2.1684E−07 | 2.4625E−06 |
| A22: | 0.0000E+00 | 0.0000E+00 | 6.7646E−09 | −1.5744E−07 |
| A24: | 0.0000E+00 | 0.0000E+00 | −6.2155E−12 | 0.0000E+00 |
| A26: | 0.0000E+00 | 0.0000E+00 | 0.0000E+00 | 0.0000E+00 |
| A28: | 0.0000E+00 | 0.0000E+00 | 0.0000E+00 | 0.0000E+00 |
| A30: | 0.0000E+00 | 0.0000E+00 | 0.0000E+00 | 0.0000E+00 |
| Surface | 6 | 7 | 8 | 9 |
| K: | −6.9386E−01 | −1.3595E+00 | −2.9918E+01 | −2.2445E+01 |
| A2: | 0.0000E+00 | 0.0000E+00 | 0.0000E+00 | 0.0000E+00 |
| A4: | 2.2404E−02 | −5.7875E−03 | −2.5170E−02 | −2.5423E−02 |
| A6: | −2.6620E−03 | 1.7175E−02 | 3.0260E−03 | 3.2448E−03 |
| A8: | 1.0527E−04 | −1.4998E−02 | −9.1688E−04 | −5.7656E−04 |
| A10: | 3.9704E−05 | 9.7906E−03 | 2.9106E−04 | 7.5307E−05 |
| A12: | 1.4825E−04 | −4.7739E−03 | −8.3275E−05 | −9.2013E−06 |
| A14: | −1.5007E−04 | 1.6982E−03 | 1.4635E−05 | 8.1505E−07 |
| A16: | 6.7654E−05 | −4.3008E−04 | −1.4050E−06 | −4.0192E−08 |
| A18: | −1.7672E−05 | 7.4886E−05 | 5.2511E−08 | 0.0000E+00 |
| A20: | 2.7836E−06 | −8.4585E−06 | 0.0000E+00 | 0.0000E+00 |
| A22: | −2.4774E−07 | 5.5427E−07 | 0.0000E+00 | 0.0000E+00 |
| A24: | 9.6460E−09 | −1.5878E−08 | 0.0000E+00 | 0.0000E+00 |
| A26: | 0.0000E+00 | 0.0000E+00 | 0.0000E+00 | 0.0000E+00 |
| A28: | 0.0000E+00 | 0.0000E+00 | 0.0000E+00 | 0.0000E+00 |
| A30: | 0.0000E+00 | 0.0000E+00 | 0.0000E+00 | 0.0000E+00 |

In the third embodiment, the curve equation of the aspheric surface profiles of the aforementioned lenses is the same as the curve equation of the first embodiment. Also, the definitions of these parameters shown in the following table are the same as those stated in the first embodiment, so an explanation in this regard will not be provided again.

These parameters can be calculated from Tables 6-7 as the following values, and the following conditions in Table 8 are satisfied.

TABLE 8
Embodiment 3

| | | | |
|---|---|---|---|
| TTL/(2*IMH) | 1.50 | ET3/ET4 | 1.05 |
| f1/f | 0.48 | R1/\|R2\| | 0.18 |
| FOV[°] | 36.74 | \|f2\|/f1 | 1.16 |
| R7/(R7 + R8) | 0.49 | \|R8\|/CT4 | 7.24 |
| f1/R1 | 1.60 | EPD[mm] | 6.09 |
| (CT1 + CT2)/(CT3 + CT4) | 2.00 | (f1 − f2)/f | 1.03 |
| CT4/CT3 | 0.84 | f/EPD | 2.15 |

### Fourth Embodiment

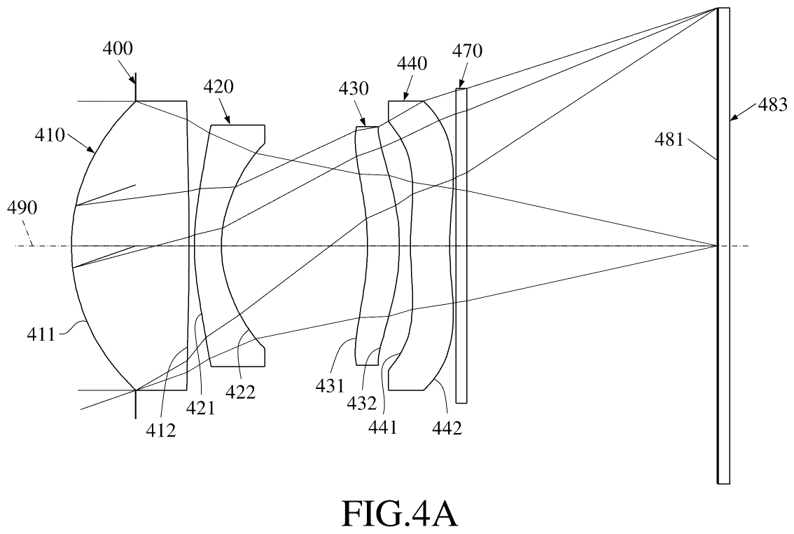

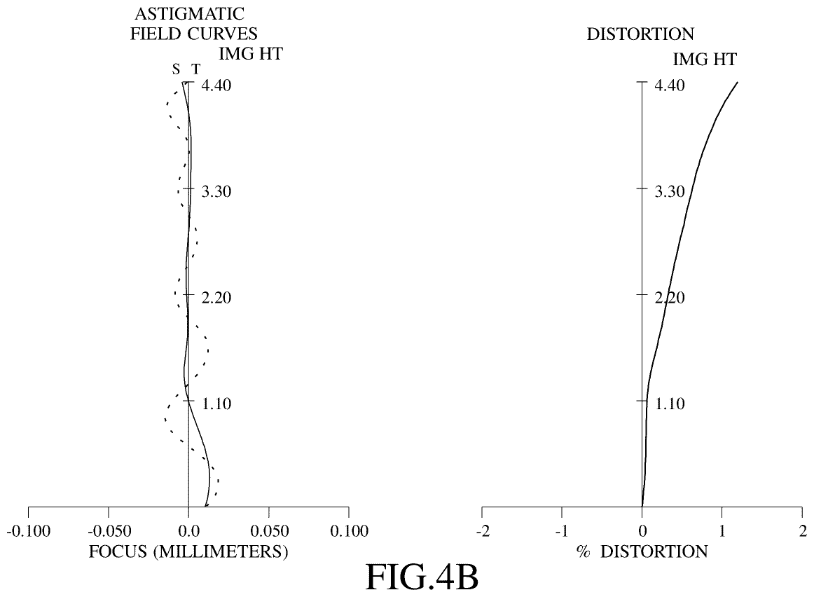

Referring to FIGS. 4A and 4B, FIG. 4A shows a schematic view of an optical lens assembly in accordance with a fourth embodiment of the present invention, and FIG. 4B shows, in order from left to right, the field curvature curve and the distortion curve of the fourth embodiment of the present invention. As shown in FIG. 4A, the optical lens assembly includes, in order from an object side to an image side: a stop 400, a first lens 410, a second lens 420, a third lens 430, a fourth lens 440, an optical filter 470, and an image plane 481. The optical lens assembly can cooperate with an image sensor 483 disposed on the image plane 481. The optical lens assembly has a total of four lenses with refractive power (410, 420, 430, 440), but is not limited thereto.

The first lens 410 with positive refractive power includes an object-side surface 411 and an image-side surface 412, the object-side surface 411 of the first lens 410 is convex in a paraxial region thereof, the image-side surface 412 of the first lens 410 is convex in a paraxial region thereof, the object-side surface 411 and the image-side surface 412 of the first lens 410 are aspheric, and the first lens 410 is made of plastic.

The second lens 420 with negative refractive power includes an object-side surface 421 and an image-side surface 422, the object-side surface 421 of the second lens 420 is convex in a paraxial region thereof, the image-side surface 422 of the second lens 420 is concave in a paraxial region thereof, the object-side surface 421 and the image-side surface 422 of the second lens 420 are aspheric, and the second lens 420 is made of plastic.

The third lens 430 with positive refractive power includes an object-side surface 431 and an image-side surface 432, the object-side surface 431 of the third lens 430 is concave in a paraxial region thereof, the image-side surface 432 of the third lens 430 is convex in a paraxial region thereof, the object-side surface 431 and the image-side surface 432 of the third lens 430 are aspheric, and the third lens 430 is made of plastic.

The fourth lens 440 with positive refractive power includes an object-side surface 441 and an image-side surface 442, the object-side surface 441 of the fourth lens 440 is convex in a paraxial region thereof, the image-side surface 442 of the fourth lens 440 is concave in a paraxial region thereof, the object-side surface 441 and the image-side surface 442 of the fourth lens 440 are aspheric, and the fourth lens 440 is made of plastic.

The optical filter 470 is made of glass, is located between the fourth lens 440 and the image plane 481, and has no influence on the focal length of the optical lens assembly. In the present embodiment, the optical filter 470 is selected from IR-cut filters that allow visible light to pass therethrough.

Please refer to Tables 9-10. The detailed optical data of the respective elements in the optical lens assembly of the fourth embodiment is shown in Table 9, and the aspheric coefficients of the lenses in the fourth embodiment are shown in Table 10.

TABLE 9
Embodiment 4
f = 12.7 mm, Fno = 2.38, FOV = 37.8°

| | | | | | | | Abbe | |
|---|---|---|---|---|---|---|---|---|
| | | Radius of | | Thickness/ | | Refractive | number | Focal |
| Surface | | curvature | | gap | Material | index (nd) | (vd) | length |
| 0 | Object | Infinity | | Infinity | | | | |
| 1 | Stop | Infinity | | −1.211 | | | | |
| 2 | First lens | 3.454 | (ASP) | 2.221 | Plastic | 1.54 | 55.9 | 5.95 |
| 3 | | −42.490 | (ASP) | 0.100 | | | | |
| 4 | Second lens | 4.501 | (ASP) | 0.510 | Plastic | 1.64 | 22.4 | −6.87 |
| 5 | | 2.138 | (ASP) | 2.763 | | | | |
| 6 | Third lens | −4.063 | (ASP) | 0.600 | Plastic | 1.67 | 19.2 | 177.60 |
| 7 | | −4.164 | (ASP) | 0.207 | | | | |
| 8 | Fourth lens | 4.636 | (ASP) | 0.738 | Plastic | 1.54 | 55.9 | 171.10 |
| 9 | | 4.604 | (ASP) | 0.121 | | | | |

| | | | | | | |
|---|---|---|---|---|---|---|
| 10 | Optical filter | Infinity | 0.210 | Glass | 1.52 | 64.2 |
| 11 | | Infinity | 4.729 | | | |
| 12 | Image plane | Infinity | 0.000 | | | |

The reference wavelength is 555 nm.

TABLE 10
Embodiment 4
Aspheric Coefficients

| Surface | 2 | 3 | 4 | 5 |
|---|---|---|---|---|
| K: | −7.5943E−02 | −9.1845E+01 | −1.3984E+00 | −1.7523E−01 |
| A2: | 0.0000E+00 | 0.0000E+00 | 0.0000E+00 | 0.0000E+00 |
| A4: | 6.1624E−05 | 4.2147E−04 | −1.8853E−02 | −2.6582E−02 |
| A6: | −8.3383E−05 | 1.1893E−03 | 2.7501E−03 | 4.4972E−03 |
| A8: | 4.7591E−05 | −7.3709E−04 | 1.4391E−03 | −2.6205E−03 |
| A10: | −1.8842E−05 | 1.8197E−04 | −2.1570E−03 | 3.3766E−03 |
| A12: | 4.0566E−06 | −2.4291E−06 | 1.3820E−03 | −3.2447E−03 |
| A14: | −5.0433E−07 | −9.4329E−06 | −5.4790E−04 | 1.9286E−03 |
| A16: | 3.0635E−08 | 2.2795E−06 | 1.4638E−04 | −7.0508E−04 |
| A18: | −4.0456E−10 | −2.2892E−07 | −2.6988E−05 | 1.5456E−04 |
| A20: | −3.0650E−11 | 8.7308E−09 | 3.3537E−06 | −1.8571E−05 |
| A22: | 0.0000E+00 | 0.0000E+00 | −2.5480E−07 | 9.3525E−07 |
| A24: | 0.0000E+00 | 0.0000E+00 | 8.9047E−09 | 0.0000E+00 |
| A26: | 0.0000E+00 | 0.0000E+00 | 0.0000E+00 | 0.0000E+00 |
| A28: | 0.0000E+00 | 0.0000E+00 | 0.0000E+00 | 0.0000E+00 |
| A30: | 0.0000E+00 | 0.0000E+00 | 0.0000E+00 | 0.0000E+00 |
| Surface | 6 | 7 | 8 | 9 |
| K: | 0.0000E+00 | 0.0000E+00 | −6.2118E+01 | −2.6929E+01 |
| A2: | 0.0000E+00 | 0.0000E+00 | 0.0000E+00 | 0.0000E+00 |
| A4: | 2.7643E−02 | −3.0428E−02 | −3.7615E−02 | −2.7162E−02 |
| A6: | −7.7067E−03 | 6.7843E−02 | 1.2249E−02 | 4.1254E−03 |
| A8: | 4.6048E−03 | −7.7601E−02 | −7.5684E−03 | −7.9599E−04 |
| A10: | −3.1097E−03 | 6.3262E−02 | 3.8355E−03 | 1.2325E−04 |
| A12: | 1.7912E−03 | −3.6473E−02 | −1.3191E−03 | −1.5870E−05 |
| A14: | −7.4171E−04 | 1.4795E−02 | 2.7903E−04 | 1.2522E−06 |
| A16: | 2.0850E−04 | −4.1805E−03 | −3.3164E−05 | −4.2686E−08 |
| A18: | −3.8499E−05 | 8.0349E−04 | 1.7061E−06 | 0.0000E+00 |
| A20: | 4.4544E−06 | −9.9979E−05 | 0.0000E+00 | 0.0000E+00 |
| A22: | −2.8860E−07 | 7.2541E−06 | 0.0000E+00 | 0.0000E+00 |
| A24: | 7.7082E−09 | −2.3274E−07 | 0.0000E+00 | 0.0000E+00 |
| A26: | 0.0000E+00 | 1.1816E−11 | 0.0000E+00 | 0.0000E+00 |
| A28: | 0.0000E+00 | 0.0000E+00 | 0.0000E+00 | 0.0000E+00 |
| A30: | 0.0000E+00 | 0.0000E+00 | 0.0000E+00 | 0.0000E+00 |

In the fourth embodiment, the curve equation of the aspheric surface profiles of the aforementioned lenses is the same as the curve equation of the first embodiment. Also, the definitions of these parameters shown in the following table are the same as those stated in the first embodiment, so an explanation in this regard will not be provided again.

These parameters can be calculated from Tables 9-10 as the following values, and the following conditions in Table 11 are satisfied.

TABLE 11
Embodiment 4

| | | | |
|---|---|---|---|
| TTL/(2*IMH) | 1.39 | ET3/ET4 | 0.63 |
| f1/f | 0.47 | R1/\|R2\| | 0.08 |
| FOV[°] | 37.80 | \|f2\|/f1 | 1.15 |
| R7/(R7 + R8) | 0.50 | \|R8\|/CT4 | 6.24 |
| f1/R1 | 1.72 | EPD[mm] | 5.34 |
| (CT1 + CT2)/(CT3 + CT4) | 2.04 | (f1 − f2)/f | 1.01 |
| CT4/CT3 | 1.23 | f/EPD | 2.38 |

### Fifth Embodiment

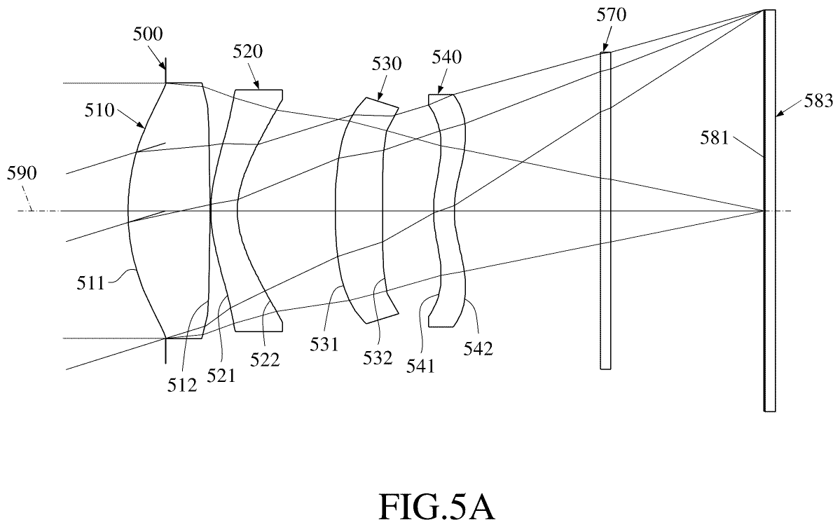

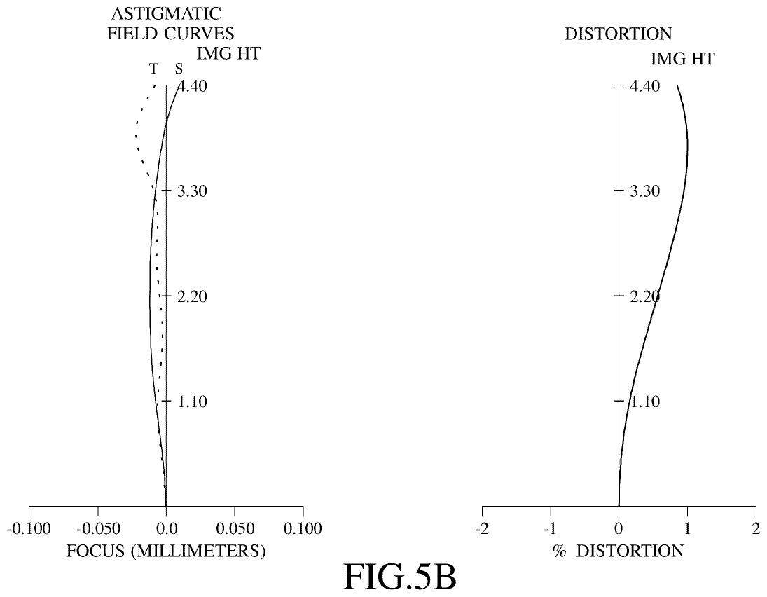

Referring to FIGS. 5A and 5B, FIG. 5A shows a schematic view of an optical lens assembly in accordance with a fifth embodiment of the present invention, and FIG. 5B shows, in order from left to right, the field curvature curve and the distortion curve of the fifth embodiment of the present invention. As shown in FIG. 5A, the optical lens assembly includes, in order from an object side to an image side: a stop 500, a first lens 510, a second lens 520, a third lens 530, a fourth lens 540, an optical filter 570, and an image plane 581. The optical lens assembly can cooperate with an image sensor 583 disposed on the image plane 581. The optical lens assembly has a total of four lenses with refractive power (510, 520, 530, 540), but is not limited thereto.

The first lens 510 with positive refractive power includes an object-side surface 511 and an image-side surface 512, the object-side surface 511 of the first lens 510 is convex in a paraxial region thereof, the image-side surface 512 of the first lens 510 is convex in a paraxial region thereof, the object-side surface 511 and the image-side surface 512 of the first lens 510 are aspheric, and the first lens 510 is made of plastic.

The second lens 520 with negative refractive power includes an object-side surface 521 and an image-side surface 522, the object-side surface 521 of the second lens 520 is convex in a paraxial region thereof, the image-side surface 522 of the second lens 520 is concave in a paraxial region thereof, the object-side surface 521 and the image-side surface 522 of the second lens 520 are aspheric, and the second lens 520 is made of plastic.

The third lens 530 with positive refractive power includes an object-side surface 531 and an image-side surface 532, the object-side surface 531 of the third lens 530 is convex in a paraxial region thereof, the image-side surface 532 of the third lens 530 is concave in a paraxial region thereof, the object-side surface 531 and the image-side surface 532 of the third lens 530 are aspheric, and the third lens 530 is made of plastic.

The fourth lens 540 with negative refractive power includes an object-side surface 541 and an image-side surface 542, the object-side surface 541 of the fourth lens 540 is convex in a paraxial region thereof, the image-side surface 542 of the fourth lens 540 is concave in a paraxial region thereof, the object-side surface 541 and the image-side surface 542 of the fourth lens 540 are aspheric, and the fourth lens 540 is made of plastic.

The optical filter 570 is made of glass, is located between the fourth lens 540 and the image plane 581, and has no influence on the focal length of the optical lens assembly. In the present embodiment, the optical filter 570 is selected from IR-cut filters that allow visible light to pass therethrough.

Please refer to Tables 12-13. The detailed optical data of the respective elements in the optical lens assembly of the fifth embodiment is shown in Table 12, and the aspheric coefficients of the lenses in the fifth embodiment are shown in Table 13.

TABLE 12
Embodiment 5
f = 13.31 mm, Fno = 2.38, FOV = 36.3°

| | | | | | | | Abbe | |
|---|---|---|---|---|---|---|---|---|
| | | Radius of | | Thickness/ | | Refractive | number | Focal |
| Surface | | curvature | | gap | Material | index (nd) | (vd) | length |
| 0 | Object | Infinity | | Infinity | | | | |
| 1 | Stop | Infinity | | −0.784 | | | | |
| 2 | First lens | 4.744 | (ASP) | 1.709 | Plastic | 1.54 | 55.9 | 7.63 |
| 3 | | −29.957 | (ASP) | 0.020 | | | | |
| 4 | Second lens | 3.310 | (ASP) | 0.549 | Plastic | 1.67 | 19.2 | −8.91 |
| 5 | | 1.995 | (ASP) | 2.040 | | | | |
| 6 | Third lens | 10.505 | (ASP) | 0.988 | Plastic | 1.64 | 24.0 | 21.13 |
| 7 | | 45.281 | (ASP) | 1.063 | | | | |
| 8 | Fourth lens | 2.734 | (ASP) | 0.430 | Plastic | 1.54 | 55.9 | −51.97 |
| 9 | | 2.355 | (ASP) | 3.053 | | | | |

| | | | | | | |
|---|---|---|---|---|---|---|
| 10 | Optical filter | Infinity | 0.210 | Glass | 1.52 | 64.2 |
| 11 | | Infinity | 3.202 | | | |
| 12 | Image plane | Infinity | 0.000 | | | |

The reference wavelength is 555 nm.

TABLE 13
Embodiment 5
Aspheric Coefficients

| Surface | 2 | 3 | 4 | 5 |
|---|---|---|---|---|
| K: | −3.2467E−01 | −9.5159E+01 | −1.7947E+00 | −4.5423E−01 |
| A2: | 0.0000E+00 | 0.0000E+00 | 0.0000E+00 | 0.0000E+00 |
| A4: | 1.0928E−03 | 5.4779E−03 | −2.0332E−02 | −4.3432E−02 |
| A6: | −3.9275E−04 | −8.3983E−04 | 4.8072E−03 | 8.6747E−03 |
| A8: | 1.0595E−04 | −2.1249E−04 | −1.2748E−03 | −2.9166E−03 |
| A10: | −2.9689E−05 | 1.0317E−04 | 1.9690E−04 | 7.8107E−04 |
| A12: | 4.8288E−06 | −2.0995E−05 | 1.0384E−06 | −1.9157E−04 |
| A14: | −5.1013E−07 | 2.2500E−06 | −6.2471E−06 | 4.0802E−05 |
| A16: | 2.7413E−08 | −1.2388E−07 | 1.1068E−06 | −6.5908E−06 |
| A18: | −6.4270E−10 | 2.7309E−09 | −8.3964E−08 | 6.4706E−07 |
| A20: | 0.0000E+00 | 0.0000E+00 | 2.4392E−09 | −2.8290E−08 |
| A22: | 0.0000E+00 | 0.0000E+00 | 0.0000E+00 | 0.0000E+00 |
| A24: | 0.0000E+00 | 0.0000E+00 | 0.0000E+00 | 0.0000E+00 |
| A26: | 0.0000E+00 | 0.0000E+00 | 0.0000E+00 | 0.0000E+00 |
| A28: | 0.0000E+00 | 0.0000E+00 | 0.0000E+00 | 0.0000E+00 |
| A30: | 0.0000E+00 | 0.0000E+00 | 0.0000E+00 | 0.0000E+00 |
| Surface | 6 | 7 | 8 | 9 |
| K: | 1.4270E+01 | 9.9000E+01 | −5.5039E+00 | −4.5282E+00 |
| A2: | 0.0000E+00 | 0.0000E+00 | 0.0000E+00 | 0.0000E+00 |
| A4: | 4.5061E−04 | −8.0661E−03 | −4.1632E−02 | −3.6716E−02 |
| A6: | 2.9724E−03 | 8.7571E−03 | 1.3865E−03 | 1.8853E−03 |
| A8: | −1.2487E−03 | −3.9936E−03 | 2.5607E−03 | 2.5404E−03 |
| A10: | 5.2140E−04 | 1.9453E−03 | −1.0942E−03 | −1.3491E−03 |
| A12: | −1.7320E−04 | −7.3894E−04 | 2.1915E−04 | 3.6181E−04 |
| A14: | 4.0521E−05 | 1.9744E−04 | −2.1758E−05 | −5.9694E−05 |
| A16: | −6.1258E−06 | −3.3766E−05 | 3.6425E−07 | 6.0353E−06 |
| A18: | 5.3467E−07 | 3.2969E−06 | 1.1815E−07 | −3.4053E−07 |
| A20: | −2.0476E−08 | −1.3754E−07 | −7.4866E−09 | 8.0371E−09 |
| A22: | 0.0000E+00 | 0.0000E+00 | 0.0000E+00 | 0.0000E+00 |
| A24: | 0.0000E+00 | 0.0000E+00 | 0.0000E+00 | 0.0000E+00 |
| A26: | 0.0000E+00 | 0.0000E+00 | 0.0000E+00 | 0.0000E+00 |
| A28: | 0.0000E+00 | 0.0000E+00 | 0.0000E+00 | 0.0000E+00 |
| A30: | 0.0000E+00 | 0.0000E+00 | 0.0000E+00 | 0.0000E+00 |

In the fifth embodiment, the curve equation of the aspheric surface profiles of the aforementioned lenses is the same as the curve equation of the first embodiment. Also, the definitions of these parameters shown in the following table are the same as those stated in the first embodiment, so an explanation in this regard will not be provided again.

These parameters can be calculated from Tables 12-13 as the following values, and the following conditions in Table 14 are satisfied.

TABLE 14
Embodiment 5

| | | | |
|---|---|---|---|
| TTL/(2*IMH) | 1.51 | ET3/ET4 | 1.30 |
| f1/f | 0.57 | R1/\|R2\| | 0.16 |
| FOV[°] | 36.30 | \|f2\|/f1 | 1.17 |
| R7/(R7 + R8) | 0.54 | \|R8\|/CT4 | 5.47 |
| f1/R1 | 1.61 | EPD[mm] | 5.59 |
| (CT1 + CT2)/(CT3 + CT4) | 1.59 | (f1 − f2)/f | 1.24 |
| CT4/CT3 | 0.44 | f/EPD | 2.38 |

### Sixth Embodiment

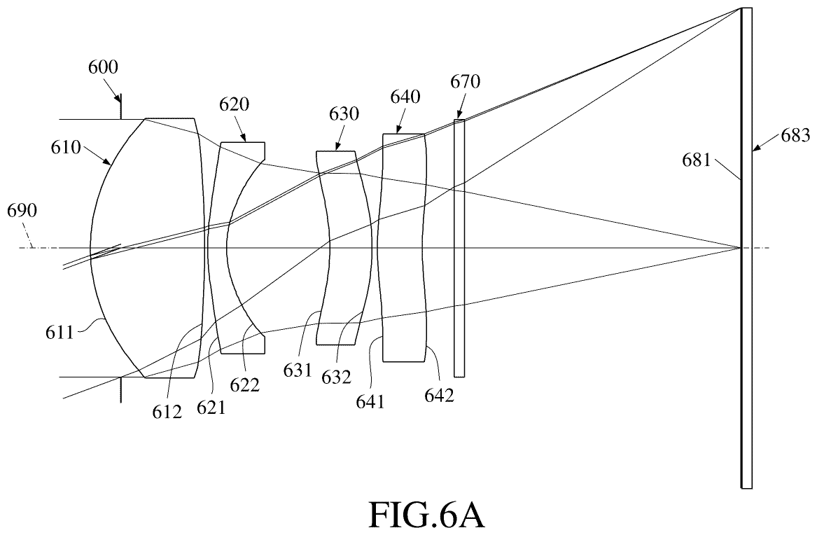

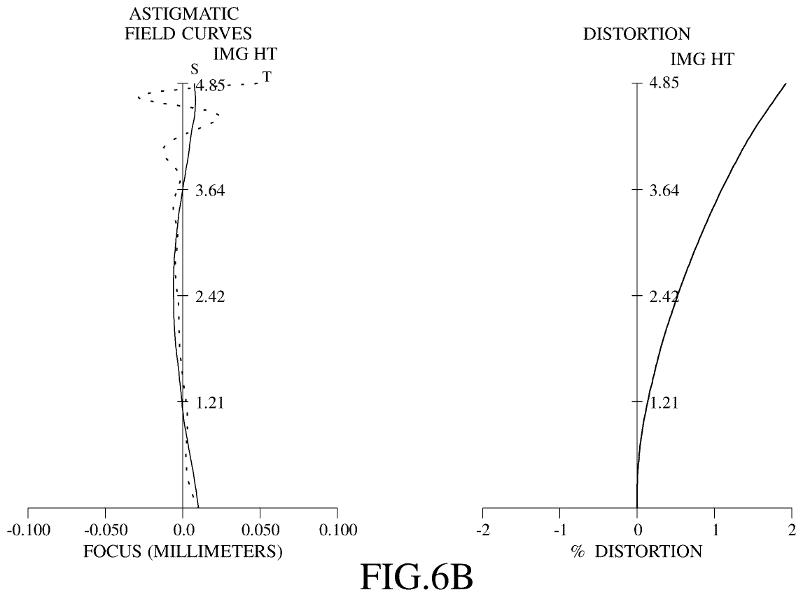

Referring to FIGS. 6A and 6B, FIG. 6A shows a schematic view of an optical lens assembly in accordance with a sixth embodiment of the present invention, and FIG. 6B shows, in order from left to right, the field curvature curve and the distortion curve of the sixth embodiment of the present invention. As shown in FIG. 6A, the optical lens assembly includes, in order from an object side to an image side: a stop 600, a first lens 610, a second lens 620, a third lens 630, a fourth lens 640, an optical filter 670, and an image plane 681. The optical lens assembly can cooperate with an image sensor 683 disposed on the image plane 681. The optical lens assembly has a total of four lenses with refractive power (610, 620, 630, 640), but is not limited thereto.

The first lens 610 with positive refractive power includes an object-side surface 611 and an image-side surface 612, the object-side surface 611 of the first lens 610 is convex in a paraxial region thereof, the image-side surface 612 of the first lens 610 is convex in a paraxial region thereof, the object-side surface 611 and the image-side surface 612 of the first lens 610 are aspheric, and the first lens 610 is made of plastic.

The second lens 620 with negative refractive power includes an object-side surface 621 and an image-side surface 622, the object-side surface 621 of the second lens 620 is convex in a paraxial region thereof, the image-side surface 622 of the second lens 620 is concave in a paraxial region thereof, the object-side surface 621 and the image-side surface 622 of the second lens 620 are aspheric, and the second lens 620 is made of plastic.

The third lens 630 with negative refractive power includes an object-side surface 631 and an image-side surface 632, the object-side surface 631 of the third lens 630 is concave in a paraxial region thereof, the image-side surface 632 of the third lens 630 is convex in a paraxial region thereof, the object-side surface 631 and the image-side surface 632 of the third lens 630 are aspheric, and the third lens 630 is made of plastic.

The fourth lens 640 with positive refractive power includes an object-side surface 641 and an image-side surface 642, the object-side surface 641 of the fourth lens 640 is convex in a paraxial region thereof, the image-side surface 642 of the fourth lens 640 is concave in a paraxial region thereof, the object-side surface 641 and the image-side surface 642 of the fourth lens 640 are aspheric, and the fourth lens 640 is made of plastic.

The optical filter 670 is made of glass, is located between the fourth lens 640 and the image plane 681, and has no influence on the focal length of the optical lens assembly. In the present embodiment, the optical filter 670 is selected from IR-cut filters that allow visible light to pass therethrough.

Please refer to Tables 15-16. The detailed optical data of the respective elements in the optical lens assembly of the sixth embodiment is shown in Table 15, and the aspheric coefficients of the lenses in the sixth embodiment are shown in Table 16.

TABLE 15
Embodiment 6
f = 12.9 mm, Fno = 2.48, FOV = 40.5°

| | | | | | | | Abbe | |
|---|---|---|---|---|---|---|---|---|
| | | Radius of | | Thickness/ | | Refractive | number | Focal |
| Surface | | curvature | | gap | Material | index (nd) | (vd) | length |
| 0 | Object | Infinity | | Infinity | | | | |
| 1 | Stop | Infinity | | −0.613 | | | | |
| 2 | First lens | 3.493 | (ASP) | 2.283 | Plastic | 1.54 | 55.9 | 5.60 |
| 3 | | −18.819 | (ASP) | 0.060 | | | | |
| 4 | Second lens | 4.320 | (ASP) | 0.378 | Plastic | 1.61 | 25.9 | −6.19 |
| 5 | | 1.963 | (ASP) | 2.065 | | | | |
| 6 | Third lens | −3.568 | (ASP) | 0.842 | Plastic | 1.66 | 20.4 | −39.31 |
| 7 | | −4.521 | (ASP) | 0.103 | | | | |
| 8 | Fourth lens | 4.409 | (ASP) | 0.897 | Plastic | 1.61 | 25.9 | 22.86 |
| 9 | | 5.906 | (ASP) | 0.637 | | | | |

| | | | | | | |
|---|---|---|---|---|---|---|
| 10 | Optical filter | Infinity | 0.210 | Glass | 1.52 | 64.2 |
| 11 | | Infinity | 5.525 | | | |
| 12 | Image plane | Infinity | 0.000 | | | |

The reference wavelength is 555 nm.

TABLE 16
Embodiment 6
Aspheric Coefficients

| Surface | 2 | 3 | 4 | 5 |
|---|---|---|---|---|
| K: | 3.3960E−01 | −1.8216E+01 | −3.1084E+00 | −1.6834E−01 |
| A2: | 0.0000E+00 | 0.0000E+00 | 0.0000E+00 | 0.0000E+00 |
| A4: | −1.1997E−03 | 3.4730E−03 | −2.9832E−02 | −4.6197E−02 |
| A6: | −4.9676E−04 | −4.5697E−04 | 1.1182E−02 | 1.4902E−02 |
| A8: | 4.6344E−04 | −1.8830E−03 | −5.9953E−03 | −9.8148E−03 |
| A10: | −4.2513E−04 | 2.3029E−03 | 4.0599E−03 | 9.8325E−03 |
| A12: | 2.3524E−04 | −1.4769E−03 | −2.2012E−03 | −9.0610E−03 |
| A14: | −8.5518E−05 | 6.0500E−04 | 8.6438E−04 | 5.9972E−03 |
| A16: | 2.0610E−05 | −1.6567E−04 | −2.4246E−04 | −2.6691E−03 |
| A18: | −3.2670E−06 | 3.0212E−05 | 4.7500E−05 | 7.6502E−04 |
| A20: | 3.2682E−07 | −3.5204E−06 | −6.1455E−06 | −1.3244E−04 |
| A22: | −1.8683E−08 | 2.3689E−07 | 4.6746E−07 | 1.2144E−05 |
| A24: | 4.6391E−10 | −6.9950E−09 | −1.5662E−08 | −4.1881E−07 |
| A26: | 0.0000E+00 | 0.0000E+00 | 0.0000E+00 | 0.0000E+00 |
| A28: | 0.0000E+00 | 0.0000E+00 | 0.0000E+00 | 0.0000E+00 |
| A30: | 0.0000E+00 | 0.0000E+00 | 0.0000E+00 | 0.0000E+00 |
| Surface | 6 | 7 | 8 | 9 |
| K: | 0.0000E+00 | 0.0000E+00 | 0.0000E+00 | 0.0000E+00 |
| A2: | 0.0000E+00 | 0.0000E+00 | 0.0000E+00 | 0.0000E+00 |
| A4 | 3.4186E−02 | −3.0170E−02 | −7.7276E−02 | −2.8098E−02 |
| A6: | −1.9718E−02 | 5.6315E−02 | 6.2467E−02 | −3.1450E−04 |
| A8: | 3.0416E−02 | −5.8779E−02 | −5.2576E−02 | 9.7369E−03 |
| A10: | −4.2981E−02 | 5.0055E−02 | 3.5428E−02 | −1.1470E−02 |
| A12: | 4.4170E−02 | −3.5359E−02 | −1.8267E−02 | 8.2137E−03 |
| A14: | −3.1960E−02 | 2.0219E−02 | 7.1502E−03 | −4.0051E−03 |
| A16: | 1.6256E−02 | −8.9315E−03 | −2.1053E−03 | 1.3646E−03 |
| A18: | −5.7669E−03 | 2.9072E−03 | 4.5846E−04 | −3.2466E−04 |
| A20: | 1.3935E−03 | −6.6479E−04 | −7.1610E−05 | 5.2827E−05 |
| A22: | −2.1804E−04 | 1.0027E−04 | 7.5887E−06 | −5.5995E−06 |
| A24: | 1.9859E−05 | −8.9183E−06 | −4.8865E−07 | 3.4821E−07 |
| A26: | −7.9663E−07 | 3.5343E−07 | 1.4427E−08 | −9.6336E−09 |
| A28: | 0.0000E+00 | 0.0000E+00 | 0.0000E+00 | 0.0000E+00 |
| A30: | 0.0000E+00 | 0.0000E+00 | 0.0000E+00 | 0.0000E+00 |

In the sixth embodiment, the curve equation of the aspheric surface profiles of the aforementioned lenses is the same as the curve equation of the first embodiment. Also, the definitions of these parameters shown in the following table are the same as those stated in the first embodiment, so an explanation in this regard will not be provided again.

These parameters can be calculated from Tables 15-16 as the following values, and the following conditions in Table 17 are satisfied.

TABLE 17
Embodiment 6

| | | | |
|---|---|---|---|
| TTL/(2*IMH) | 1.34 | ET3/ET4 | 0.93 |
| f1/f | 0.43 | R1/\|R2\| | 0.19 |
| FOV[°] | 40.50 | \|f2\|/f1 | 1.11 |
| R7/(R7 + R8) | 0.43 | \|R8\|/CT4 | 6.58 |
| f1/R1 | 1.60 | EPD[mm] | 5.20 |
| (CT1 + CT2)/(CT3 + CT4) | 1.53 | (f1 − f2)/f | 0.91 |
| CT4/CT3 | 1.07 | f/EPD | 2.48 |

For the optical lens assembly in the present invention, the lenses can be made of plastic or glass. If the lens is made of plastic, it is conducive to reducing the manufacturing cost. If the lens is made of glass, it is conducive to enhancing the degree of freedom in the arrangement of refractive power of the optical lens assembly. Moreover, any of the object-side and image-side surfaces of a respective lens of the optical lens assembly can be aspheric, and the aspheric surface can have any profile shape other than the profile shape of a spherical surface, so more variables can be used in the design of aspheric surfaces (than spherical surfaces), which is conducive to reducing the aberration and the number of lenses, as well as the total length of the optical lens assembly.

In the optical lens assembly of the present invention, the optical filter is made of, but not limited to, glass and can be made of other materials with high Abbe numbers.

For the optical lens assembly in the present invention, if the surface shape of a respective lens surface of a respective lens with refractive power is convex and the location of the convex portion of the respective lens surface of the respective lens is not defined, the convex portion is typically located in a paraxial region of the respective lens surface of the respective lens. If the surface shape of a respective lens surface of a respective lens is concave and the location of the concave portion of the respective lens surface of the respective lens is not defined, the concave portion is typically located in a paraxial region of the respective lens surface of the respective lens.

The optical lens assembly of the present invention can be used in focus-adjustable optical systems according to the actual requirements and have good aberration correction ability and better image quality. The optical lens assembly of the present invention can also be used in electronic imaging systems, such as, 3D image capturing device, wearable display of virtual reality (VR) or augmented reality (AR), game player, surveillance camera, digital camera, mobile device, tablet computer, or vehicle camera.

What is claimed is:

1. An optical lens assembly, in order from an object side to an image side, comprising:
a first lens with positive refractive power, including an image-side surface being convex in a paraxial region thereof;
a second lens with negative refractive power;
a third lens; and
a fourth lens;
wherein a thickness of the third lens at a maximum effective diameter position of the third lens is ET3, a thickness of the fourth lens at a maximum effective diameter position of the fourth lens is ET4, and the following condition is satisfied:
$$0.48 < ET 3 / ET 4 < 1.5 .$$

2. The optical lens assembly as claimed in claim 1, wherein a distance from an object-side surface of the first lens to an image plane along an optical axis is TTL, a maximum image height of the optical lens assembly is IMH, and the following condition is satisfied: 1.14<TTL/(2*IMH)<1.74.

3. The optical lens assembly as claimed in claim 1, wherein a maximum field of view of the optical lens assembly is FOV, and the following condition is satisfied:
$$30 ° < FOV < 47 ° .$$

4. The optical lens assembly as claimed in claim 1, wherein a focal length of the first lens is f1, a focal length of the optical lens assembly is f, and the following condition is satisfied: 0.37<f1/f<0.66.

5. The optical lens assembly as claimed in claim 1, wherein an entrance pupil diameter of the optical lens assembly is EPD, and the following condition is satisfied:
$$4.42 mm < EPD < 7. mm .$$

6. The optical lens assembly as claimed in claim 1, wherein a radius of curvature of an object-side surface of the fourth lens is R7, a radius of curvature of an image-side surface of the fourth lens is R8, and the following condition is satisfied:
$$1.18 < ( CT 1 + CT 2 ) / ( CT 3 + CT 4 ) < 2.35 .$$

7. The optical lens assembly as claimed in claim 1, wherein a focal length of the first lens is f1, a radius of curvature of an object-side surface of the first lens is R1, and the following condition is satisfied: 1.36<f1/R1<2.04.

8. The optical lens assembly as claimed in claim 1, wherein a thickness of the first lens along an optical axis is CT1, a thickness of the second lens along the optical axis is CT2, a thickness of the third lens along the optical axis is CT3, a thickness of the fourth lens along the optical axis is CT4, and the following condition is satisfied:
$$0.35 < R 7 / ( R 7 + R 8 ) < 0.62 .$$

9. The optical lens assembly as claimed in claim 1, wherein a thickness of the third lens along an optical axis is CT3, a thickness of the fourth lens along the optical axis is CT4, and the following condition is satisfied: 0.37<CT4/CT3<1.76.

10. The optical lens assembly as claimed in claim 1, wherein a radius of curvature of an object-side surface of the first lens is R1, a radius of curvature of the image-side surface of the first lens is R2, and the following condition is satisfied:
$$0.03 < R 1 / \vert R 2 \vert < 0.21 .$$

11. The optical lens assembly as claimed in claim 1, wherein a focal length of the first lens is f1, a focal length of the second lens is f2, and the following condition is satisfied: 0.94<|f2|/f1<1.35.

12. The optical lens assembly as claimed in claim 1, wherein a radius of curvature of an image-side surface of the fourth lens is R8, a thickness of the fourth lens along an optical axis is CT4, and the following condition is satisfied:
$$4.65 < \vert R 8 \vert / CT 4 < 11.03 .$$

13. The optical lens assembly as claimed in claim 1, wherein a focal length of the first lens is f1, a focal length of the second lens is f2, a focal length of the optical lens assembly is f, and the following condition is satisfied: 0.78<(f1−f2)/f<1.43.

14. The optical lens assembly as claimed in claim 1, wherein a focal length of the optical lens assembly is f, an entrance pupil diameter of the optical lens assembly is EPD, and the following condition is satisfied: 1.83<f/EPD<2.97.
